(19) United States
(12) Patent Application Publication
(10) Pub. No.: US 2004/0190379 A1
(43) Pub. Date: Sep. 30, 2004

(54) Electronic equipment system and time correction method

(75) Inventor: Makoto Akiba, Saitama-shi (JP)

Correspondence Address: LEYDIG VOIT & MAYER, LTD, 700 THIRTEENTH ST. NW, SUITE 300, WASHINGTON, DC, 20005-3960, US

(73) Assignee: Fuji Photo Optical Co., Ltd., Saitama-shi (JP)

(21) Appl. No.: 10/809,386

(22) Filed: Mar. 26, 2004

(30) Foreign Application Priority Data
Mar. 28, 2003 (JP) 2003-091077

(51) Int. Cl. G04C 11/02

(52) U.S. Cl. 368/47

(57) ABSTRACT

The A camera system according to the present invention comprises includes a remote controller for transmitting a remote control signal consisting of including a command signal and a subsequent time data signal, and a camera for receiving the remote control signal for correcting time information, the. The camera determining determines whether it is to carry out a time correction or not, based on the basis of the state of the receipt of the command signal.

### BACKGROUND OF THE INVENTION

1. Field of the Invention

The present invention relates to an electronic equipment system correcting the time of electronic equipment according to a remote control signal, and a time correction method thereof.

2. Related Background Art

There has been disclosed in the Patent Document 1 and the like an electronic equipment system in which time information of the electronic equipment is corrected based on a signal from external equipment.

The remote controller with an automatic time correction function specified in Patent Document 1 transmits a signal D including an operation command signal D1 and a time signal D2 to a VTR. The CPU of the VTR separates the time signal D2 from the operation command signal D1 and sends the time signal D2 to the correction circuit, by which a time value is corrected.

[Patent Document 1]

Japanese Unexamined Patent Publication (Tokukai) Number H08-195991

### SUMMARY OF THE INVENTION

However, in the invention described in the Patent Document 1, when the leading operation command signal D1 can not be received due to a noise or the like, the electronic equipment (VTR) is not operated and the time of it is not corrected. In this invention, since the time signal D2 is separated from the signal D, it is determined whether the time correction is performed or not after the whole of the signal D has been received.

The present invention aims to provide an electronic equipment system and time correction method which solve the above problems, determine in an early stage whether the operation command signal can be received, and reduce the effect of a noise.

An electronic equipment system according to the present invention comprises a remote controller for transmitting a remote control signal consisting of a command signal and a subsequent time data signal, and electronic equipment for receiving the remote control signal to correct time information, the electronic equipment comprising a determining means for determining whether time correction is performed or not based on the state of the receipt of the command signal.

In the electronic equipment system, it is determined whether time correction is performed or not on the basis of the state of the receipt of the command signal transmitted preceding the time data signal. Thereby, when no command signal can be received, the receiving process can be stopped in an early stage, and furthermore there is made possible a start of a efficiently as to whether the remote control signal is received again or whether the interruption of an key input is performed.

In the electronic equipment system, the remote control signal may consist of two identical command signals and a subsequent time data signal, and the determining means may determine, when the second command signal is normally received, that time correction is performed, and determine, when the second command signal is not normally received, that time correction is not performed.

Since the remote control signal includes two identical command signals, the chattering of the received signal in the electronic equipment can be reduced, and when the second command signal is normally received, the signal subsequently received can be obtained as a time data signal. It is therefore preferably determined, when the second command signal is received, that time correction is performed.

In the electronic equipment system, the electronic equipment may have a first mode in which time correction is not performed, and a second mode in which time correction is performed, and the determining means may determine in case of the first mode that time correction is not performed, and determine in case of the second mode whether time correction is performed or not based on the state of the receipt of the command signal.

The time correction of the electronic equipment may be performed well at every predetermined relatively long interval or when the power is turn on, but may not be performed frequently. For this reason, the electronic equipment preferably has a first mode of carrying out no time correction and a second mode of carrying out a time correction and determines whether time correction is performed or not based on its mode. Thereby, the user of the electronic equipment can set a timing of time correction.

In the electronic equipment system, the electronic equipment is preferably a camera. In a camera system, a remote control signal including a command signal and a time data signal is transmitted from its remote controller to its camera. For this reason, the present invention may be preferably applied to a camera system.

A time correction method according to the present invention is a time correction method for correcting the time of electronic equipment based on a remote control signal transmitted from a remote controller, comprising the steps of: a transmitting step of transmitting a remote control signal containing a command signal and a subsequent time data signal from said remote controller to said electronic equipment; a determining step of determining whether said electronic equipment is to carry out time correction or not, on the basis of the state of the receipt of said command signal transmitted in said remote control signal transmitting step.

In the time correction method, it is determined whether time correction is performed or not on the basis of the state of the receipt of the command signal transmitted preceding the time data signal. Thereby, when no command signal can be received, the receiving process can be stopped in an early stage, and furthermore there is made possible a start of a efficiently as to whether the remote control signal is received again or whether the interruption of an key input is performed.

In the time correction method, the remote control signal may consist of two identical command signals and a subsequent time data signal, and in the determining step, it may be determined, when the second command signal is normally received, that time correction is performed, and it may be determined, when the second command signal is not normally received, that time correction is not performed.

Since the remote control signal includes two identical command signals, the chattering of the received signal in the electronic equipment can be reduced, and when the second command signal is normally received, the signal subsequently received can be obtained as a time data signal. It is therefore preferably determined, when the second command signal is received, that time correction is performed.

In the time correction method, the electronic equipment may have a first mode in which time correction is not performed, and a second mode in which time correction is performed, and in the determining step, it may be determined in case of the first mode that time correction is not performed, and it may be determined in case of the second mode whether time correction is performed or not based on the state of the receipt of the command signal.

Time correction for the electronic equipment may be performed well at predetermined relatively long intervals or when the power is turned on, but may not be performed frequently. For this reason, the electronic equipment preferably has a first mode in which time correction is not performed, and a second mode in which time correction is performed, and determines whether time correction is performed or not based on its mode. In such configuration, the user of the electronic equipment can set a timing of time correction.

In the time correction method, the electronic equipment is preferably a camera. In a camera system, a remote control signal containing a command signal and a time data signal is transmitted from its remote controller to its camera. For this reason, the present invention may be preferably applied to a camera system.

### BRIEF DESCRIPTION OF THE DRAWINGS

FIG. 1 is a perspective view showing a camera system according to the embodiment.

FIG. 2 is a block diagram showing the configuration of the remote controller shown in FIG. 1.

FIG. 3 is an outline view showing a partial configuration of the remote controller shown in FIG. 1.

Each of FIGS. 4A-4C is a figure showing an example of the display of a date and time on the LCD shown in FIG. 3: FIG. 4A shows an example of the full display; FIG. 4B shows an example of the display of date; and FIG. 4C shows an example of the display of time.

Each of FIGS. 5A and 5B is a figure depicting a remote control signal transmitted from the remote controller: FIG. 5A shows a release signal; and FIG. 5B shows a date signal.

FIG. 6 is a block diagram showing the configuration of the camera shown in FIG. 1.

FIG. 7 is an outline showing a partial configuration of the camera shown in FIG. 1.

FIG. 8 is a figure showing an example of full display on the LCD shown in FIG. 7.

FIG. 9 is a flow chart showing the SM open process of the camera shown in FIG. 1.

FIG. 10 is a flow chart showing the operation of the camera according to the embodiment.

FIG. 11 is a flow chart showing the operation of the camera according to the embodiment.

Each of FIGS. 12A and 12B is a figure depicting the operation of the camera according to the embodiment.

### DESCRIPTION OF THE PREFERRED EMBODIMENTS

With reference to accompanying drawings there will be made a description of a preferred embodiment of the present invention below. Dimensions shown in the figures and described Dimensions are not drawn to scale. In the drawings, the same reference numerals or symbols denote the same or corresponding elements. Repetitive description is omitted.

In the embodiment, there will be made a description of a camera system as an exemplary embodiment of an electronic equipment system.

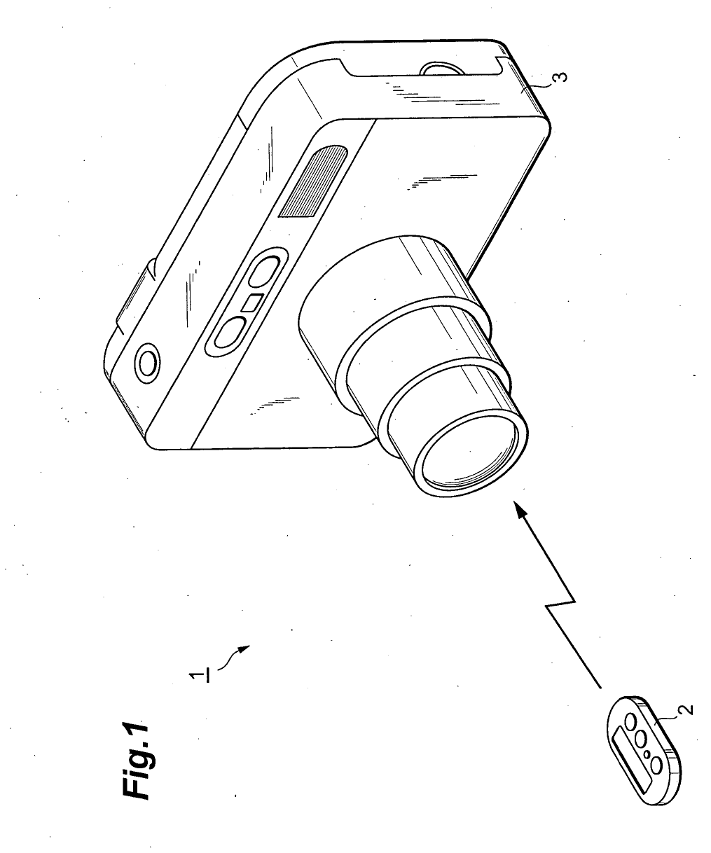

FIG. 1 is a perspective view showing the configuration of a camera system according to the embodiment. As shown in FIG. 1, the camera system 1 according to the embodiment comprises a remote controller 2 and the main unit (called camera hereinafter) 3, and is able to transmit a predetermined signal to the camera 3 by operating the remote controller 2.

The remote controller 2 is an external equipment capable of transmitting a remote control signal to the camera 3. The camera 3 has a photographing function and a receiving function of receiving a signal transmitted from the remote controller 2. When the camera 3 is set to a mode in which it is operated by the remote controller 2, it is made possible to receive a remote control signal transmitted from the remote controller 2, and performs a predetermined process based on the remote control signal. In the camera system 1 according to the embodiment, the remote control operation mode includes a first mode in which zoom and release operations are performed, a second mode in which time information of the camera is corrected, and a third mode in which the operations are performed and the time information is corrected. These modes can be switched over by operations. The “remote control signal” described above is a data signal, a command signal, or the like, more specifically, a command signal (operation signal) such as a release signal allowing the camera to perform a release operation, or a time data signal (date signal) having information related to date and time.

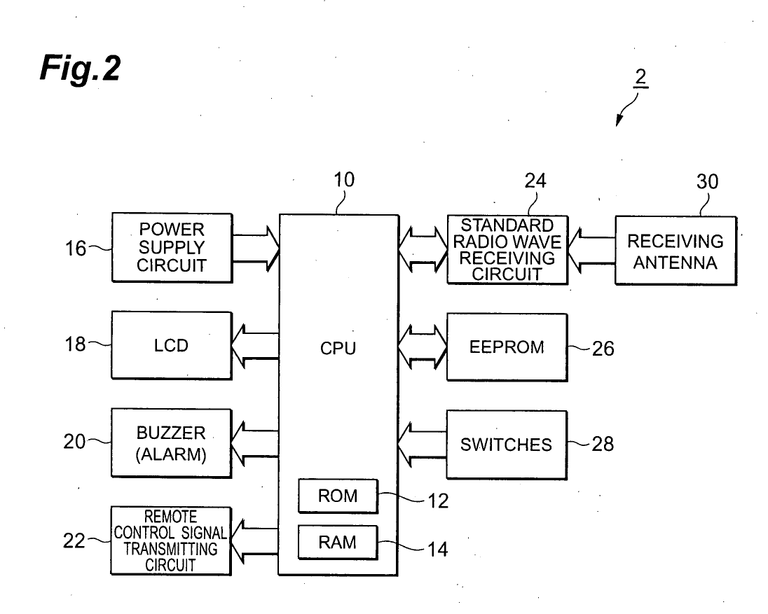

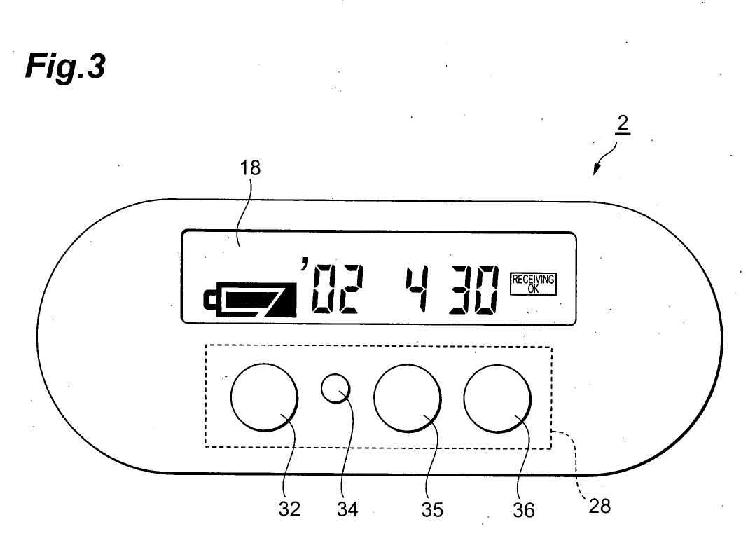

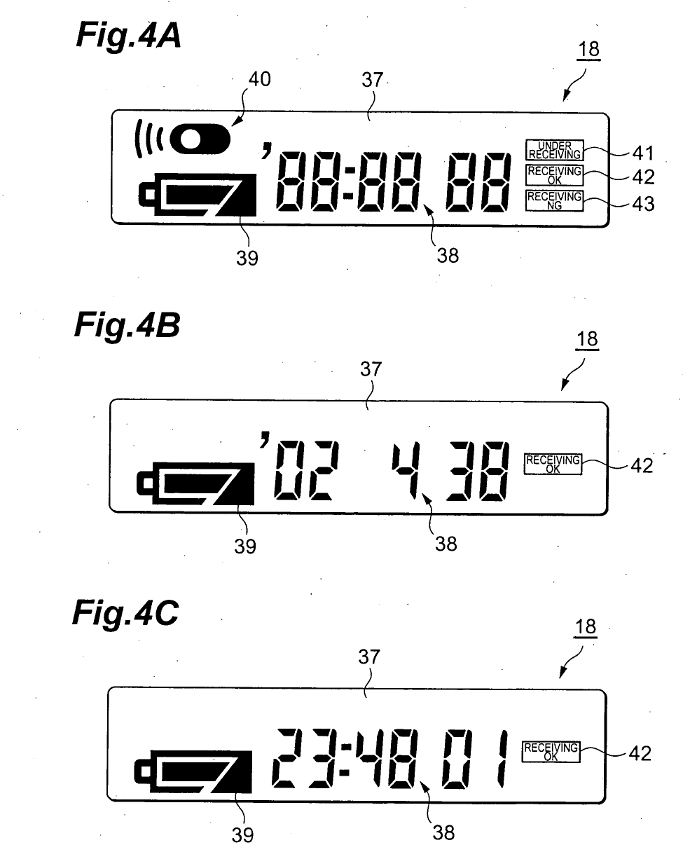

Next, the remote controller 2 will be explained in detail with reference to FIGS. 2 and 3. FIG. 2 is a block diagram showing the configuration of the remote controller 2 shown in FIG. 1, and FIG. 3 is an outline view showing a partial configuration of the remote controller 2 shown in FIG. 1.

As shown in FIG. 2, the remote controller 2 has a CPU 10 for controlling the whole of the remote controller 2. The CPU 10 contains a ROM 12 in which programs for control and computation processes are stored in advance, and a RAM 14 for storing various data at the time of control or computation. The CPU 10 has a clock function of counting up seconds, minutes, hours, days, months, and years based on a reference clock.

The CPU 10 is connected to a power supply circuit 16, a LCD 18, a buzzer (alarm) 20, a remote control signal transmitting circuit 22, a standard radio wave receiving circuit 24, an EEPROM 26, and switches 28. The power supply circuit 16 supplies the power from a battery or the like to the CPU 10. The LCD 18 displays the quantity of electricity stored in the battery or the like, and a date and time counted by the CPU 10. The LCD 18 also displays whether the standard radio wave has been normally received.

The buzzer 20 makes a notification sound indicating that a remote control signal is transmitted when it is transmitted, and a notification sound indicating whether the standard radio wave has been normally received. The remote control signal transmitting circuit 22 transmits a remote control signal to the camera 3, using infrared rays, for example. The standard radio wave receiving circuit 24 receives the standard radio wave. The standard radio wave receiving circuit 24 is connected with a receiving antenna 30. The receiving antenna 30 receives the standard radio wave, and is constituted, for example, in such a way that a lead wire is wound around a ferrite core. When the remote controller 2 receives the standard radio wave, it corrects a date and time counted by the CPU 10 to obtain the ones based on the standard radio wave. Thus, the remote controller 2 is able to display the information about a correct date and time.

The EEPROM 26 stores a state of the remote controller at every point of time, various kinds of control parameters, and the like. The switches 28 include, as shown in FIG. 3, a date switch 32, a setting switch 34, a date signal transmitting switch 35, and a release signal transmitting switch 36.

The date switch 32 is used for changing the format of a date and time displayed on the LCD 18, for example, from “year-month-day” to “day-hour-minute”. The date switch also has a function of changing the order to be corrected during the date-and-time correction mode, for example, from “year” to “month” or from “month” to “day”.

The setting switch 34 is used for correcting a date and time displayed on the LCD 18, wherein for example, there are counted up years, months, and days during the date-and-time correction mode. By operating this switch 34, the display of year, for example, can be changed from “01” to “02”. The date signal transmitting switch 35 is used for transmitting a date signal about date and time. The release signal transmitting switch 36 is used for transmitting a release signal allowing the camera 3 to perform a release operation.

Examples of the display of a date and time displayed on the LCD 18 when the date switch 32 is operated are described below. Each of FIGS. 4A-4C shows an example of the display of a date and time on the LCD 18 shown in FIG. 3. FIG. 4A shows an example of full display, FIG. 4B shows an example of the display of a date, and FIG. 4C shows an example of the display of a time.

As shown in FIG. 4A, the LCD 18 has a display area 37 providing a date and time display 38 related to a year, month, day, hour, minute, and second, a battery mark display 39 showing the quantity of electricity stored in the battery, and a transmission display 40 showing that a remote control signal containing a release signal and date signal has been transmitted. The display area 37 also provides an under-receiving display 41, a normal-receiving display, and an abnormal-receiving display. For example, the under-receiving display 41 is comprised of the characters “UNDER RECEIVING”, the normal-receiving display 42 consists of the characters “RECEIVING OK”, and the abnormal-receiving display 43 consists of the characters “RECEIVING NG”. The under-receiving display 41, the normal-receiving display 42, and the abnormal-receiving display 43 are not limited to the above characters, but may be symbols such as antenna mark, etc.

By operating the date switch 32, the display on the LCD 18 is changed over, for example, from FIG. 4B to FIG. 4C, or from FIG. 4C to FIG. 4B. In the display area 37 shown in FIG. 4B, a “year-month-day” is displayed as the date and time display 38. In the display area 37 shown in FIG. 4C, an “hour-minute-second” is displayed as the date and time display 38. That is, the user of the remote controller 2 may operate the date switch 32 to select a desired display state. In FIGS. 4B and 4C, the battery mark display 39 and the normal-receiving display 42 are also provided.

Next, a remote control signal transmitted from the remote controller 2 will be explained with reference to FIGS. 5A and 5B. The remote control signal consists of a command signal and a subsequent time data signal. FIGS. 5A and 5B depict a remote control signal transmitted from the remote controller 2. FIG. 5A shows an example of the remote control signal in which a release signal is transmitted as a command signal. FIG. 5B shows an example of date signal transmitted subsequently to the release signal. More specific description is provided below.

At first, the release signal will be explained with reference to FIG. 5A. The release signal contains a header code at the head of it. The camera 3 is able to recognize the head of the received signal by detecting the header code. The release signal also contains a first release code following the header code. The release signal also contains a second release code following the first release code. The second release code is identical with the first release code. When the camera 3 has received the first release code or the second release code, it performs a release operation.

Such being the case, the release signal consists of the header code, the first release code, and the second release code. The reason why the two release codes are contained is that even if the camera has failed to receive the first release code, it can receives the second release code to perform a release operation.

Next, the date signal will be explained with reference to FIG. 5B. The date signal contains a year code, a month code, a day code, an hour code, a minute code, and a second code in this order. These codes contain the information representing a year, month, day, hour, minute, and second respectively. The date signal is recognized as such because of being transmitted subsequently to the first release signal and the second release signal.

As such, the date signal consists of a year code, a month code, a day code, an hour code, a minute code, and a second code. The date signal depends on a date and time counted by the CPU 10, and if the remote controller 2 receives the standard radio wave and corrects a date and time counted by the CPU 10, the information about the date and time contained in the date signal to be transmitted, that is, the information contained in the codes becomes to be based on the standard radio wave.

The operation signal contained in the remote control signal transmitted from the remote controller 2 is not limited to the release signal, and may be a signal other than the release signal, such as a zoom signal or power on/off signal.

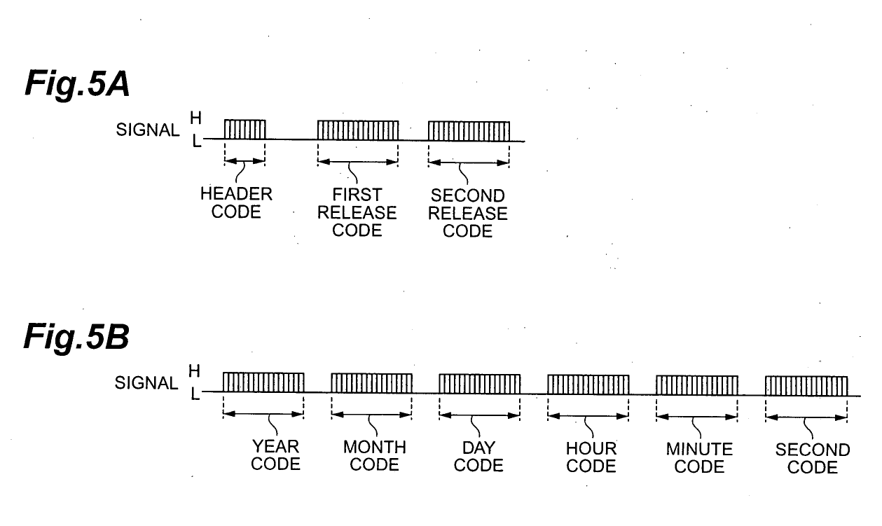

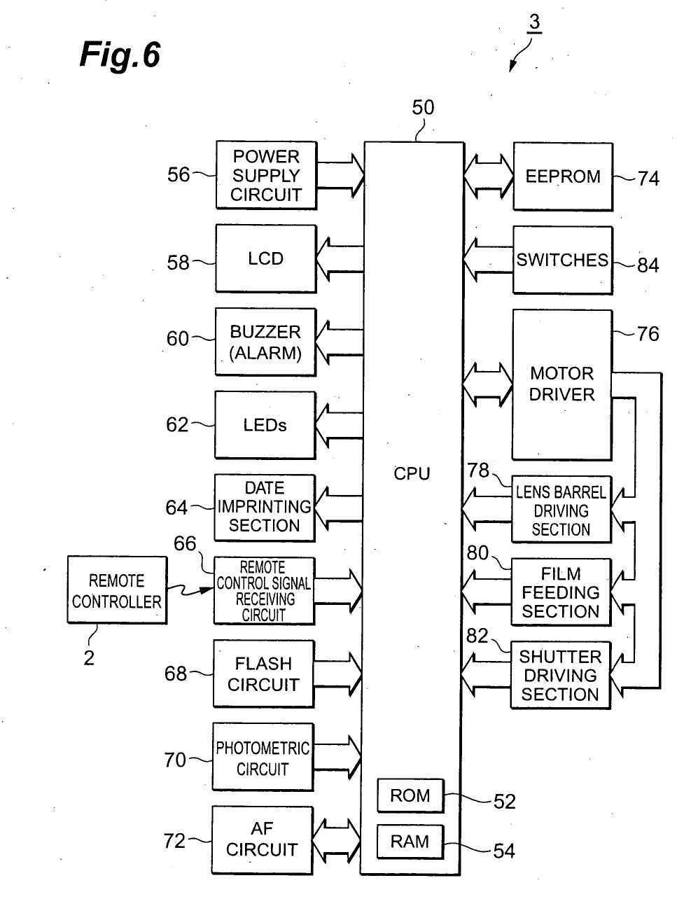

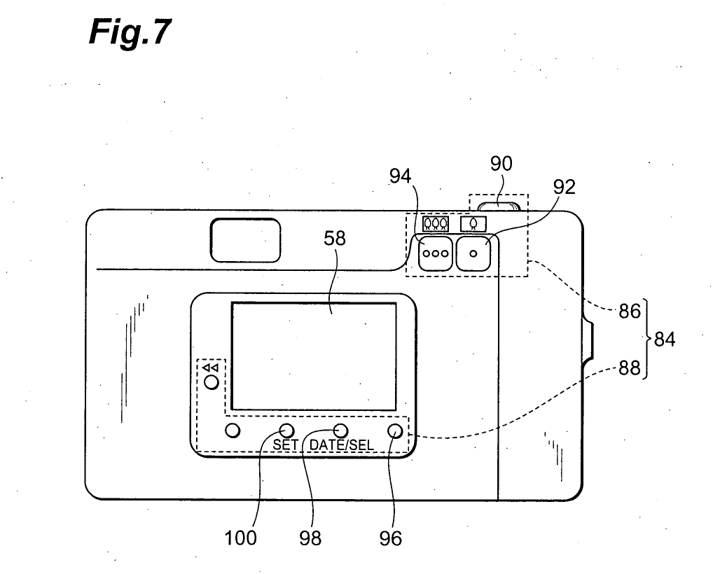

Next, the camera 3 will be in more details with reference to FIGS. 6 and 7. FIG. 6 is a block diagram showing the electrical configuration of the camera 3 shown in FIG. 1, and FIG. 7 is an outline view showing a partial configuration of the camera 3 shown in FIG. 1. FIG. 7 shows the back of the camera 3.

As shown in FIG. 6, the camera 3 has a CPU 50 including a ROM 52 and a RAM 54. The CPU 50 contains a ROM 52 in which programs for control and computation processes are stored in advance, and a RAM 54 for storing various data at the time of control or computation. The CPU 50 has a clock function of counting up seconds, minutes, hours, days, months, and years based on a reference clock. The function of the “determining means” stated in claims is realized in such a manner that the CPU 50 reads the program stored in the ROM 52 to execute it. The CPU 50 is connected with a power supply circuit 56, a LCD 58, a buzzer 60, LEDs 62, a date imprinting section 64, a remote control signal receiving circuit 66, a flash circuit 68, a photometric circuit 70, an AF circuit 72, an EEPROM 74, a motor driver 76, a lens barrel driving section 78, a film feeding section 80, a shutter driving section 82, and switches 84. The power supply circuit 56, the LCD 58, the buzzer (alarm) 60, and the EEPRO 74 are similar to those of the remote controller 2.

The LEDs 62 include a LED for auto-focus, a LED for self-mode, and the like, and indicate the states of the camera 3 by turn-on, turn-off, etc. The date imprinting section 64 imprints a date and time when a photographing is performed, and the like on a film. The remote control signal receiving circuit 66 receives a remote control signal from the remote controller 2.

The flash circuit 68 contains a light-emitting element provided in the flash window, and causes the light-emitting element to flash according to a selected mode (a mode associated with a light-emitting manner of the flash and the like) under the control of the CPU 50.

The photometric circuit 70 detects the brightness of the light incident through the photographic lens from a subject to decide an F-number and a shutter speed when the automatic exposure function is selected. The AF circuit 72 is a distance measuring circuit for automatic focus control, and contains, for example, a light-emitting element and a light-receiving element in the AF light-transmitting window and the light-receiving window respectively. The AF circuit 72 measures the distance to a subject, using the light-emitting element and light-receiving element, based on the principle of triangulation distance measurement, according to the instruction from the CPU 50, and outputs the result of the measurement to the CPU 50.

The motor driver 76 receives a control signal from the CPU 50 to output driving signals to the lens barrel driving section 78, the film feeding section 80, and the shutter driving section 82. When receiving the driving signal, the lens barrel driving section 78 expands or collapses the lens barrel, the film feeding section 80 feeds the film of the film cartridge charged in the camera, in the forward direction or the backward direction, and the shutter driving section 82 drives the shutter.

The switches 84 includes, as shown in FIG. 7, photographic switches 86 and setting switches 88. The photographic switches 86 include switches such as a release switch 90, TELE switch 92, and WIDE switch 94 associated with photography. The release switch 90 allows the camera to perform a release operation. A photographer can take a photograph by operating this switch. The TELE switch 92 and the WIDE switch 94 are used for zooming. A photographer can take a photograph of a subject as is the case where the photographer is near the subject by operating the TELE switch 2, and can take a photograph of a subject as is the case where the photographer is away from the subject by operating the WIDE switch 94.

The setting switches 88 include a power switch 96, a date switch 98, and a setting switch 100. The power switch 96 is used for switching between the supply and the shut-off of power from the power supply circuit 56 to the CPU 50. The date switch 98 has a function similar to that of the remote controller 2, and a function as a switching section for switching dates and times imprinted by the date imprinting section 64. The setting switch 100 is similar to that of the remote controller 2.

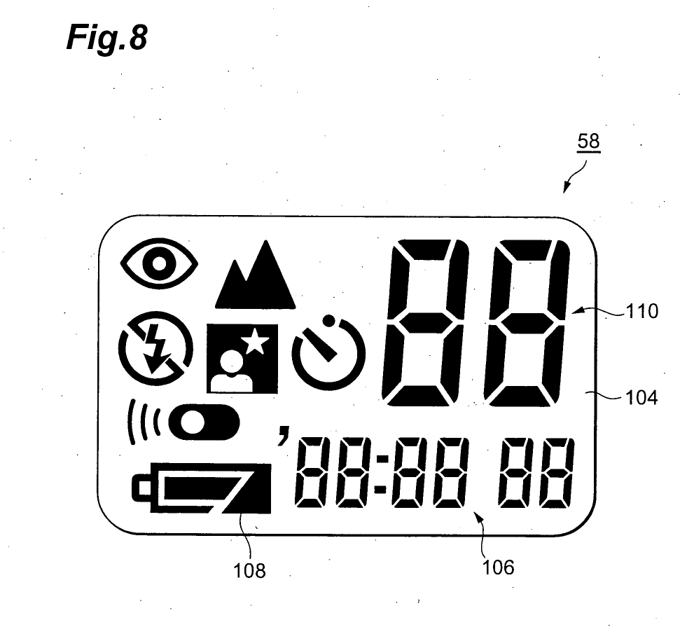

Next, displays on the LCD 58 of the camera 3 will be explained with reference to FIG. 8, which shows an example of full display on the LCD 58 shown in FIG. 7. The LCD 58 has a display area 104 providing a date and time display 106 related to a year, month, day, hour, and minute, a battery mark display 108 showing the quantity of electricity stored in the battery, a film frame number display 110 showing the number of unexposed frames or the number of exposed frames of a film, and the like.

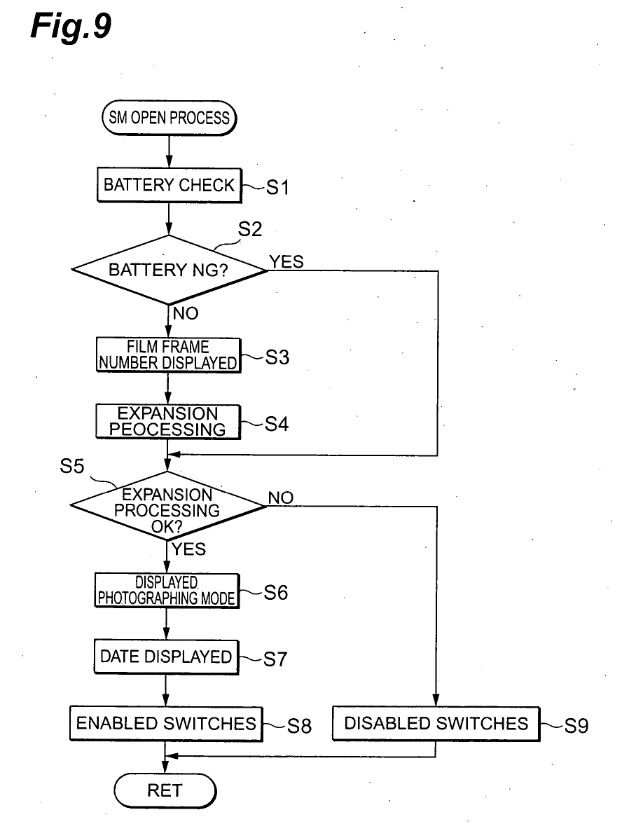

Next, the SM open process of the camera 3 will be explained with reference to FIG. 9. The SM open process is a process of expanding the lens barrel from the camera, and the like to enable the camera to take a photograph.

FIG. 9 is a flow chart showing the SM open process of the camera shown in FIG. 1. The SM open process is performed in such a case that the power switch 96 is operated to turn on the power supply circuit 56 in a state that the power to the CPU 50 is shut off by the power supply circuit 56, and then power is supplied to the CPU 50.

At first, battery check is performed in step S1. The battery check is a processing of checking the voltage of the battery of the camera 3. After the check, the process goes to step S2. In step S2, it is determined whether the voltage of the battery is a NG value. When it is determined that the voltage of the battery is a NG value, the process goes to step S5. On the other hand, when it is determined that the voltage of the battery is not a NG value, the process goes to step S3.

In step S3, the number of frames of the film is displayed. Here, the number of frames of the film is displayed as a numerical value in the film frame number display area 110. Then, the process goes to step S4, where the expansion processing is performed. In this processing, the lens barrel driving section 78 which has received a driving signal from the motor driver 76 expands the lens barrel. Then, the process goes to step S5.

In step 5, it is determined whether the expansion processing is OK. That is, it is determined whether the lens barrel has been normally expanded. This determination is made, for example, depending on whether the lens barrel has been expanded to a preset WIDE position. When it is determined that the expansion processing is OK, the process goes to step S6, where a photographing mode is displayed. This display is a display of a mode associated with a light-emitting manner of the flash, or the like. Along with this display, it is not displayed whether the displayed mode is the date correction mode or the photographic mode.

Then, the process goes to step S7, where a date and time is displayed. In this step, a date and time is displayed as numerical values in the date and time display area 106 of the LCD 58 of the camera 3. After that, the process goes to step S8, where the switches 90 to 100 are enabled. Then, a series of processing are finished.

On the other hand, when it is determined in step S5 that the expansion processing is not OK, the process goes to step S9, where the switches 90 to 100 are disabled. Then, a series of processing are finished. Each of the switches 90 to 100 is enabled or disabled by switching between the IN port and OUT port corresponding to the switch.

When the SM open process is normally finished, the switches 90 to 100 are enabled. Thus, the operation and the like of the camera 3 are made possible by the switches.

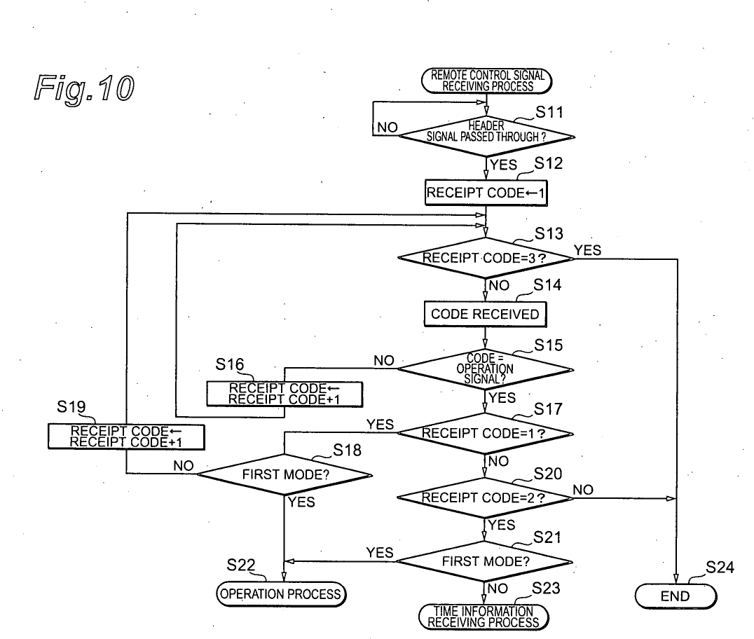

Next, the operation of the camera 3 based on the remote control signal transmitted from the remote controller 2 will be described with reference to the flow chart of FIG. 10. As described above, the operation process is performed when the camera 3 is in the first mode, time correction is carried out when the camera 3 is in the second mode, and the operation process and time correction are performed when the camera 3 is in the third mode.

As shown in FIG. 10, the remote control signal receiving process is started, and then the camera 3 determines in step S11 whether a header signal has passed through it. In the following flow, operations of the camera 3 such as making a determination and deciding a step where the process goes to are realized when the CPU 50 reads programs previously stored in the ROM 52 and executes computation and control based on the programs. When it is determined that a header signal has passed through it, “1” is substituted by the receipt code to initialize the receipt code in step S12. When it is determined that a header signal has not passed through it, the process goes to step S11 again where it is determined whether a header signal has passed through it.

In step S13 following step S12, it is determined whether the receipt code is “3”. When the receipt code is “3”, the process goes to step S24, where the remote control signal receiving process is finished. When the receipt code is not “3”, a code transmitted from the remote controller 2 is received in step S14. Now, since the receipt code has been initialized to “1”, the process goes to step S14 to receive a code. Next, it is determined in step S15 whether the received code is an operation signal (command signal). When the received code is not an operation signal, the receipt code is incremented in step S16, and then the process goes to step S13. When the received code is an operation signal, it is determined in step S17 whether the receipt code is “1”. When the receipt code is “1”, the process goes to step S18 to determine whether the camera 3 is in the first mode. When it is determined whether the camera 3 is in the first mode, the process goes to step S22 to perform the operation process based on the received code. When it is determined in step S18 that the camera 3 is not in the first mode, the receipt code is incremented in step S19, and then the process goes to step S13.

When it is determined in step S17 that the receipt code is not “1”, it is determined in step S20 whether the receipt code is “2”. When it is determined in step S20 that the receipt code is not “2”, the process goes to step S24 to finish the remote control signal receiving process. When it is determined in step S20 that the receipt code is “2”, it is determined in step S21 whether the camera 3 is in the first mode. When the camera 3 is in the first mode, the process goes to step S22 to perform the operation process based on the received command. When the camera 3 is not in the first mode, the process goes to step S23 to perform the time information receiving process based on a date signal received after the operation signal.

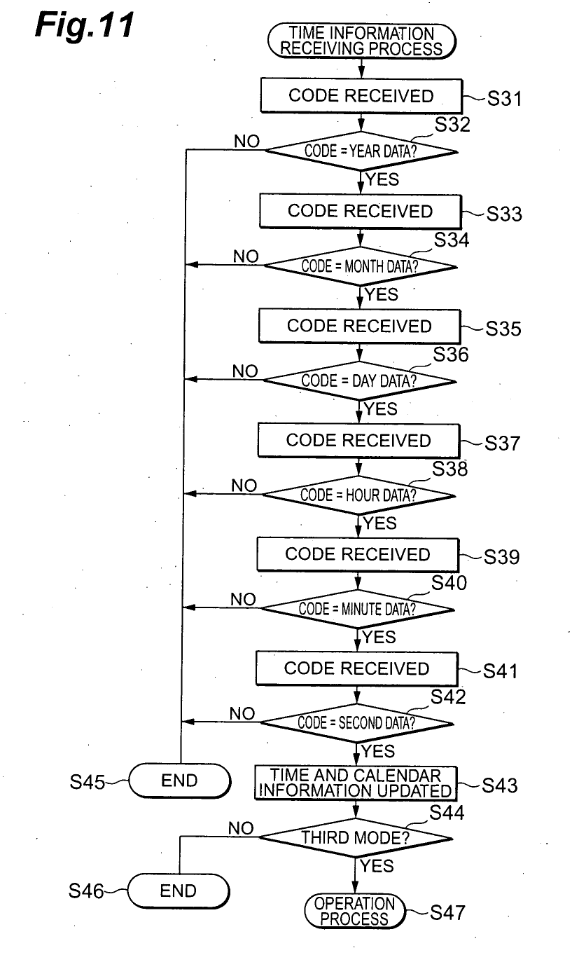

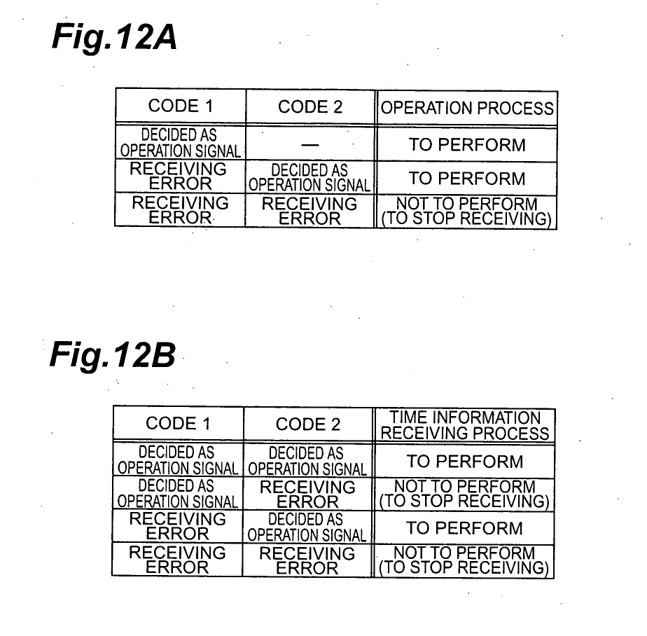

Next, the time information receiving process will be described with reference to FIG. 11. In the time information receiving process, the camera 3 receives a code transmitted from the remote controller 2 in step S31, and then determines in the subsequent step S32 whether the received code is year data. When the received code is not year data, the process goes to step S45 to finish the time information receiving process. When the received code is year data, the camera 3 receives a code transmitted from the remote controller 2 in step S33, and then determines in the subsequent step S34 whether the received code is month data. When the received code is not month data, the process goes to step S45 to finish the time information receiving process. When the received code is month data, the camera 3 receives a code transmitted from the remote controller 2 in step S35, and then determines in the subsequent step S36 whether the received code is day data. When the received code is not day data, the process goes to step S45 to finish the time information receiving process. When the received code is day data, the camera 3 receives a code transmitted from the remote controller 2 in step S37, and then determines in the subsequent step S38 whether the received code is hour data. When the received code is not hour data, the process goes to step S45 to finish the time information receiving process. When the received code is hour data, the camera 3 receives a code transmitted from the remote controller 2 in step S39, and then determines in the subsequent step S40 whether the received code is minute data. When the received code is not minute data, the process goes to step S45 to finish the time information receiving process. When the received code is minute data, the camera 3 receives a code transmitted from the remote controller 2 in step S41, and then determines in the subsequent step S42 whether the received code is second data. When the received code is not second data, the process goes to step S45 to finish the time information receiving process. When the received code is second data, the camera 3 updates time and calendar information in step S43.

Next, it is determined in step S44 whether the camera 3 is in the third mode. When the camera 3 is in the third mode, the operation process is performed based on the received command in step S47. When the camera 3 is not in the third mode., the process goes to step S46 to finish the time information receiving process.

In the above flows, the operation process is performed under the condition shown in FIG. 12A in the first or third mode, and the time information receiving process is performed under the condition shown in FIG. 12B in the second or third mode. That is, in the first mode, when either the first code or second code is an operation signal, the camera 3 performs the operation process based on its command. In the second mode, when the second code is an operation signal, time information is received to correct the time information of the camera 3. In the third mode, the time information receiving process is performed, and then the operation process is performed in step S47 (see FIG. 11).

In the camera system 1 according to this embodiment or the time correction method of the camera system 1, the camera 3 determines whether it performs time correction or not based on the state of the receipt of the command signal of a remote control signal transmitted from the remote controller 2, thus being able to stop the receiving process in an early stage when it is unable to receive the command signal. Consequently, the camera 3 is able to efficiently start to determine whether it receives the remote control signal again or whether it performs the interruption of a key input.

Furthermore, the camera 3 has the first mode in which it performs the operation process, the second mode in which it performs time correction, and the third mode in which it performs the operation process or time correction. Thus, even if a command signal and a date signal are transmitted in a fixed format from the remote controller, the camera system is able to decide what process it performs. Normally, it is not necessary to perform time correction frequently, and thereby the process can be performed efficiently by making it possible to set such modes.

As described above, it is determined whether time correction is performed or not based on the state of the receipt of the command signal transmitted before the time data signal, and thereby, when the command signal can not be received, the receiving process can be stopped in an early stage, and it can be started efficiently to determine whether the remote control signal is received again or whether the interruption of an key input is performed.

1. An electronic equipment system comprising:
a remote controller for transmitting a remote control signal containing a command signal and a time data signal subsequent to said the command signal; and
an electronic equipment for receiving said the remote control signal to correct time information, said electronic equipment comprising determining means for determining whether to carry out time correction or not the basis of the based on state of receiving said the command signal.

2. The electronic equipment system according to claim 1, wherein said the remote control signal contains identical first and second command signals and said the time data signal, and said determining means determines,
when the second command signal is received in order, to carry out the time correction, while it determines and,
when the second command signal is not received in order, not to carry out the time correction.

3. The electronic equipment system according to claim 1, wherein
said electronic equipment has a first mode of carrying out no time correction and a second mode of carrying out the time correction, and
wherein said determining means determines, in case of when the first mode being is active, not to carry out the time correction, whereas it determines and, in case of when the second mode being is active, whether to carry out the time correction or not on the basis of based on the state of receiving said the command signal.

4. The electronic equipment system according to claim 2, wherein
said electronic equipment has a first mode of carrying out no time correction and a second mode of carrying out the time correction, and
wherein said determining means determines, in case of when the first mode being is active, not to carry out the time correction, whereas it determines and, in case of when the second mode being is active, whether to carry out the time correction or not on the basis of based on the state of receiving said the command signal.

5. The electronic equipment system according to claim 1, wherein said electronic equipment is a camera.

6. A time correction method of correcting the time of an electronic equipment based on a remote control signal transmitted from a remote controller, comprisingthe steps of:
a transmitting step of transmitting a remote control signal containing a command signal and a time data signal subsequent to said the command signal from said remote controller to said electronic equipment; and
a determing step of determining whether said electronic equipment is to carry out time correction or not, based on the basis of the state of receiving said the command signal transmitted in said transmitting step.

7. The time correction method according to claim 6, wherein
said the remote control signal contains two identical first and second command signals and said the time data signal, and
wherein the time correction is determined to be carried out, in said determining step, when the second command signal is received in order, while and the time correction is determined not to be carried out, in said determing step, when the second command signal is not received in order.

8. The time correction method according to claim 6, wherein
said electronic equipment has a first mode of carrying out no time correction and a second mode of carrying out the time correction, and
wherein the time correction is determined not to be carried out, in said determining step when said electronic equipment is in the first mode, whereas there is determined and
whether said electronic equipment is to carry out the time correction or not on the basis of is based on the state of receiving said the command signal, when said electronic equipment is in the second mode.

9. The time correction method according to claim 7, wherein
said electronic equipment has a first mode of carrying out no time correction and a second mode of carrying out the time correction, and
wherein the time correction is determined not to be carried out, in said determining step when said electronic equipment is in the first mode, whereas there is determined and
whether said electronic equipment is to carry out the time correction or not on the basis of is based on the state of receiving said the command signal, when said electronic equipment is in the second mode.

10. The time correction method according to claim 6, wherein said electronic equipment is a camera.
